(19) United States
(12) Patent Application Publication
(10) Pub. No.: US 2011/0131740 A1
(43) Pub. Date: Jun. 9, 2011

(54) ENERGY STORAGE BRIDGE

(76) Inventors: CARLOS WONG, MACAU (MO); LIVIA WONG, MACAU (MO); ZHAOHUI XIONG, Harbin (CN)

(21) Appl. No.: 12/967,004

(22) Filed: Dec. 13, 2010

Related U.S. Application Data
(63) Continuation-in-part of application No. 12/211,194, filed on Sep. 16, 2008, now Pat. No. 7,874,036.

(51) Int. Cl. E01D 19/12; F15B 1/027

(52) U.S. Cl. 14/78

(57) ABSTRACT

An energy storage bridge includes a plurality of bridge girders and a bridge deck. The bridge girders include multiple steel pipes for carrying loads and storing energy in a form of compressed air contained therein and a plurality of web plates. The bridge deck is disposed on top of the bridge girders and configured for loading live loads. The steel pipes are assembled in at least a row aligned vertically. Each web plate connects a row of the steel pipes at a center line separating the steel pipes into two halves. Alternatively, a steel pipe is connected by two webs at the two sides of the pipe. Each bridge girder forms an energy storage unit between two consecutive movement joints of the energy storage bridge. Every two consecutive storage units are joined by a high pressure flexible pipe to form a giant energy storage unit. Each energy storage unit is provided with inlet and outlet pipes to in-take compressed air from electric compressors driven by the grid power or by regenerated powers, and to release the compressed air to generate electricity. The bridge girders are disposed at a predetermined transverse spacing across the width of the bridge deck and configured for supporting the bridge deck as a roadway surface.

### CROSS-REFERENCE TO RELATED APPLICATIONS

This application is a continuation-in-part of U.S. patent application Ser. No. 12/211,194, entitled “ENERGY STORAGE BRIDGE”, filed on Sep. 16, 2008.

### FIELD OF THE PATENT APPLICATION

The present patent application relates to energy storage technologies and more particularly to an energy storage bridge that utilizes steel pipes instead of the traditional beams as load carrying girders and in addition as a Compressed Air Energy Storage (CAES) units, to store the energy of unwanted electricity in the grid during low-demand sessions, or the intermittent power of any regenerated energy sources such as wind and solar energy sources.

### BACKGROUND

Underground caverns have been used for Compressed Air Energy Storage in power plants first in Germany Huntorf in 1978 (Crotogina et al 2001) and later in McIntosh power plant of Alabama, USA in 1991 (Linden 2003). The Energy Storage Unit of a power plant is to regulate the mismatching supply and demand of the grid power, so that the electricity would not be wasted when it is not needed. To store the equivalent energy of a power plant, a sizable container is needed. Surface mounted or buried steel pipes have been proposed for small energy storage units (Linden 2003). Suitable underground caverns are difficult to find. Bridge structures are plentiful in many cities and their body space (spacing between girders) is voluminous. If steel pipes are used to store energy, they can be used as load-carrying beams/girders. The key to the application is that the steel pipe when subject to internal air pressure, the pipe is under tension. The hoop stress is twice as much as the axial stress, as illustrated in FIG. 15. If the design is to limit the hoop stress to the yield stress, the axial stress is only half of the yield stress, leaving another half of the yield stress to be mobilized to carry loads. As the air pressure is very high in order to store sufficient energy, the thickness of the steel pipe is sizable. The mobilized tension force in the pipe (half of the yield stress times sectional area) is large enough to resist the vehicle load. The mass energy storage scheme can be implemented in the sea-crossing bridges such as the Sunshine Bridge, whilst small energy storage schemes can be placed in many road bridges in cities. The present patent application is to turn the bridge body space into energy storage container but at the same time maintaining its bridge function, i.e. carrying vehicle loads from A to B over a horizontal distance.

### SUMMARY

The present patent application is directed to an energy storage bridge. In one aspect, the energy storage bridge includes a plurality of bridge girders and a bridge deck disposed on top of the bridge girders and configured for loading the live loads. The bridge girders include a plurality of steel pipes configured to be used as load carrying structural members for carrying the bridge dead load and live loads including vehicle loads and configured to store energy in a form of compressed air contained therein, and a plurality of web plates. The steel pipes are assembled in at least a row aligned vertically. Each web plate connects a row of the steel pipes at a center line separating the steel pipes into two halves. Each bridge girder forms an energy storage unit between two consecutive movement joints of the energy storage bridge. Every two consecutive storage units are joined by a high pressure flexible pipe to form a giant energy storage unit. Each energy storage unit is provided with inlet and outlet pipes to in-take compressed air from electric compressors driven by the grid power or by regenerated powers, and to release the compressed air to generate electricity. The bridge girders are disposed at a predetermined transverse spacing across the width of the bridge deck and configured for supporting the bridge deck as a roadway surface.

The regenerated powers may include wind and solar energies. The heat extracted from the air compression cycle may be used to heat water which is stored in a heat-insulated tank. The water stored in the heat-insulated tank may be supplied to consumers for hot water consumption. The compressed air may be supplied to the consumers for compressed air consumption for air conditioning.

The bridge deck may be a concrete slab or a steel deck or an orthotropic steel plate deck. The energy storage bridge may further include a plurality of web stiffeners welded to the web plates and configured for stiffening the web plates. The high pressure flexible pipes may have a smaller diameter than the steel pipes and the web stiffeners may not be welded to the high pressure flexible pipes.

Holes may be formed in the web plates close to the midspan thereof. The holes may be configured to let the air inside the steel pipes move freely so as to balance the internal pressure of the steel pipes.

The energy storage bridge may further include a plurality of air pressure release units close to supports at the mid-depth of the steel pipes and a plurality of sacrificial valves. Each sacrificial valve includes a profiled bolt socket welded to the wall of the steel pipes, a profiled washer, a gauge plate, a capping ring and a plurality of bolts.

In another aspect, the energy storage bridge includes a plurality of bridge girders and a bridge deck disposed on top of the bridge girders and configured for loading the live loads. The bridge girders includes a plurality of steel pipes configured to be used as load carrying structural members for carrying the bridge dead load and live loads including vehicle loads and configured to store energy in a form of compressed air contained therein. The steel pipes are assembled in at least a row aligned vertically. Two web plates are welded to two sides of each steel pipe respectively. Each bridge girder forms an energy storage unit between two consecutive movement joints of the energy storage bridge. Every two consecutive storage units are joined by a high pressure flexible pipe to form a giant energy storage unit. Each energy storage unit is provided with inlet and outlet pipes to in-take compressed air from electric compressors driven by the grid power or by regenerated powers, and to release the compressed air to generate electricity. The bridge girders are disposed at a predetermined transverse spacing across the width of the bridge deck and configured for supporting the bridge deck as a roadway surface.

In yet another aspect, the energy storage bridge includes a bridge girder and a bridge deck disposed on top of the bridge girder. The bridge girder includes a steel pipe configured to be used as a load carrying structural member for carrying the bridge dead load and live loads including vehicle loads and configured to store energy in a form of compressed air contained therein, and a plurality of web plates. Each steel pipe is connected by two web plates on its two sides. The bridge girder forms an energy storage unit between two consecutive movement joints of the energy storage bridge. Every two consecutive storage units are joined by a high pressure flexible pipe to form a giant energy storage unit. Each energy storage unit is provided with inlet and outlet pipes to in-take compressed air from electric compressors driven by the grid power or by regenerated powers, and to release the compressed air to generate electricity.

### BRIEF DESCRIPTIONS OF THE DRAWINGS

FIG. 1A is a top plan view of an energy storage bridge according to an embodiment of the present patent application.

FIG. 1B is a side elevation view of the energy storage bridge depicted in FIG. 1A.

FIG. 2A is a top plan view of a segment of a typical span of the energy storage bridge depicted in FIG. 1A.

FIG. 2B is a side elevation view of the segment of a typical span of the energy storage bridge depicted in FIG. 1A.

FIG. 3 is a bottom view of the segment of a typical span of the energy storage bridge depicted in FIG. 1A.

FIG. 4 is a partial cross-sectional view of a deck of the energy storage bridge depicted in FIG. 1A.

FIG. 5 is a partial cross-sectional view of the deck depicted in FIG. 4 showing a section of the deck close to the bridge bearing support.

FIG. 6 is a side elevation view of the pipes at a pier support of the energy storage bridge depicted in FIG. 1A.

FIG. 7 illustrates the assembly of a segment of the deck depicted in FIG. 4.

FIG. 8 illustrates the skeleton of a piping girder of the energy storage bridge depicted in FIG. 1A after the concrete slab is removed.

FIG. 9 highlights the arrangement of the intermediate diaphragm and the air pressure release units around the diaphragm at the mid-depth of the pipe depicted in FIG. 6.

FIG. 10 highlights the arrangement of the support diaphragm, the linkage pipe, the load bearing stiffeners and the shear connectors of the energy storage bridge depicted in FIG. 1A.

FIG. 11 is another partial perspective view of the energy storage bridge depicted in FIG. 10.

FIG. 12 shows the pressure release unit “Sacrificial Valve”, as a second line safety measure in the energy storage bridge depicted in FIG. 10.

FIG. 13 shows the schematic application of the energy storage bridge as depicted in FIG. 1A to sea-crossing bridges.

FIG. 14 shows the schematic application of the energy storage bridge as depicted in FIG. 1A to city road bridges.

FIG. 15 illustrates the design principles of the energy storage bridge as depicted in FIG. 1A.

FIG. 16 is a cross-sectional view of an energy storage bridge according to another embodiment of the present patent application.

### DETAILED DESCRIPTION

Reference will now be made in detail to a preferred embodiment of the energy storage bridge disclosed in the present patent application, examples of which are also provided in the following description. Exemplary embodiments of the energy storage bridge disclosed in the present patent application are described in detail, although it will be apparent to those skilled in the relevant art that some features that are not particularly important to an understanding of the energy storage bridge may not be shown for the sake of clarity.

Furthermore, it should be understood that the energy storage bridge disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

To store mass energy only two methods are available: pumped Hydro-electric plant and Compressed Air Energy Storage (CAES). Pumped Hydro-electric plant requires two reservoirs at different levels but its application is restricted by natural terrain. The electricity is stored as potential energy. Compressed Air Energy Storage (CAES) is to compress the air to a high pressure (80 bars in Huntorf plant). Air is abundant in the atmosphere and in CAES method the only hurdle is the compressed air container.

The present patent application is an alternative to the mass energy storage using underground caverns attached to power plants as in the case of Huntorf plant of Germany and in the case of McIntosh plant of Alabama, to regulate the supply and demand of the grid power. Both plants use underground caverns at a depth of 650-850 m (Huntorf) below ground and 450 m (McIntosh) below ground level. Apart from the economical benefit from operating the power plant with a mass energy storage unit, the energy saving scheme also helps to cut the green house gases, and such scheme should be encouraged. However, suitable natural underground caverns are not easy to come by hence an alternative method of using steel pipes buried underground is proposed by Linden 2003.

Bridge structure usually consists of two parts: the girders which can be concrete or steel, and the roadway slab, which is generally made of concrete. The girder needs adequate structural depth, normally in 1/15 to 1/25 of the span. The width of the bridge depends on how many traffic lanes it is to carry. One traffic lane takes up a width of 3.5 m to 3.75 m depending on the countries' standards. The width of the roadway is about 15-16 m, for 3 lanes plus hard shoulder. For a span of typically 35-70 m, the depth is somewhere between 2.3-3.5 m. A box of 3.0 m×8 m=24 m² to 4.0 m×8.0 m=32 m² is the typical internal area of the cross-section of box girder. This figure will be doubled in dual carriageway bridges. Many bridges are constructed in great length. The available volume (sectional area times length) is great.

The air volume is provided in the internal void of a box girder or between beams. A rectangular box type structure is not suitable for resisting high air pressure (up to 100 bars, or 10 MN/m²) as it produces unfavorable bending effects. To resist the high air pressure, steel pipes are the only choice, since the internal pressure will produce only in-plane tensile stress, which is a stress to be more favorable than the bending stress, for the steel plate.

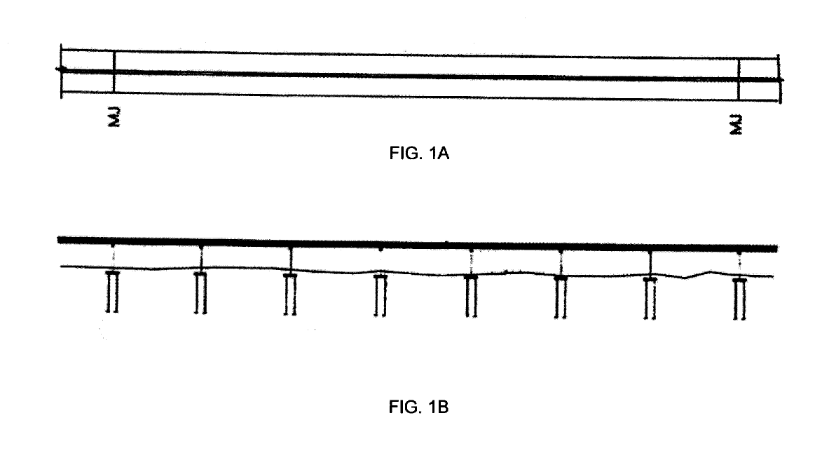

FIG. 1A is a top plan view of an energy storage bridge according to an embodiment of the present patent application. FIG. 1B is a side elevation view of the energy storage bridge depicted in FIG. 1A. Since the bridge has to be designed to take on the expansion/contraction of the bridge deck due to temperature variation, movement joints (MJ) are used at approximately every 500 m or less if continuous bridge structures are used. The bridge deck is separated at the MJ. The piping elements are therefore terminated at the MJs, resulting a storage unit of about 500 m length or less. The inlet and outlet pipes are flexible pipes to cater for the bridge deck movement.

The flexible pipes are able to resist high pressure and are commercially available. ESB Units can be linked by high pressure flexible pipes to form a large storage.

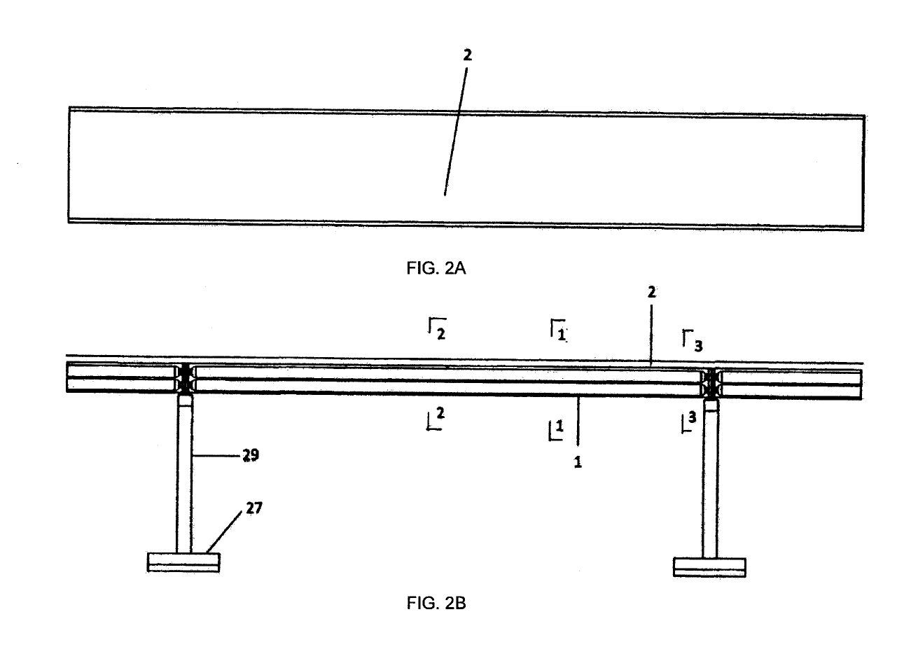

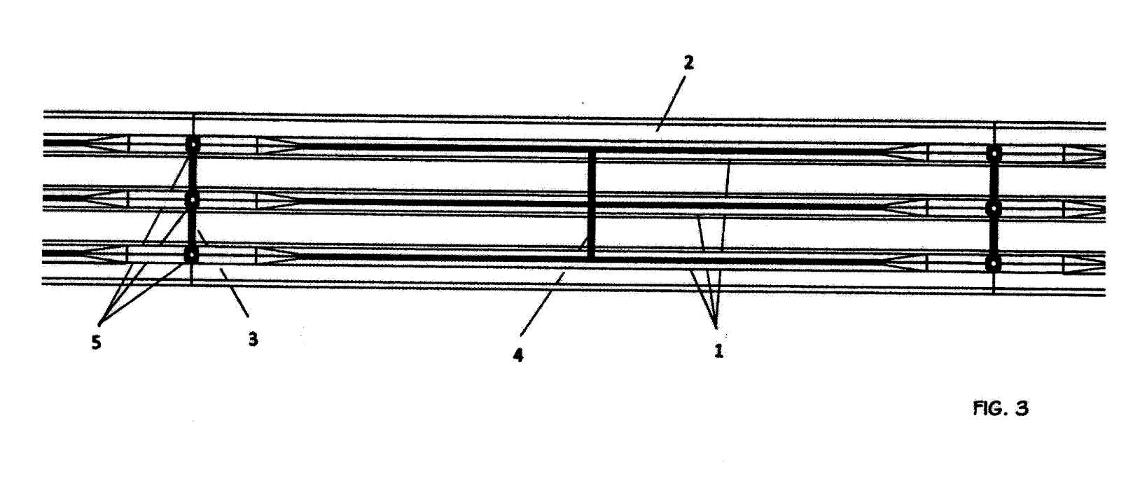

FIG. 2A is a top plan view of a segment of a typical span of the energy storage bridge depicted in FIG. 1A. FIG. 2B is a side elevation view of the segment of a typical span of the energy storage bridge depicted in FIG. 1A. FIG. 3 is a bottom view of the segment of a typical span of the energy storage bridge depicted in FIG. 1A. Referring to FIG. 2A, FIG. 2B and FIG. 3, apart from the CAES steel pipes 1, the deck is provided with support diaphragm 3 and intermediate diaphragm 4 at the midspan. The diaphragms are needed to resist the torsion of the deck due to unsymmetrical vehicle loads. The bearings 5 are used to transfer the vehicle loads to the substructure.

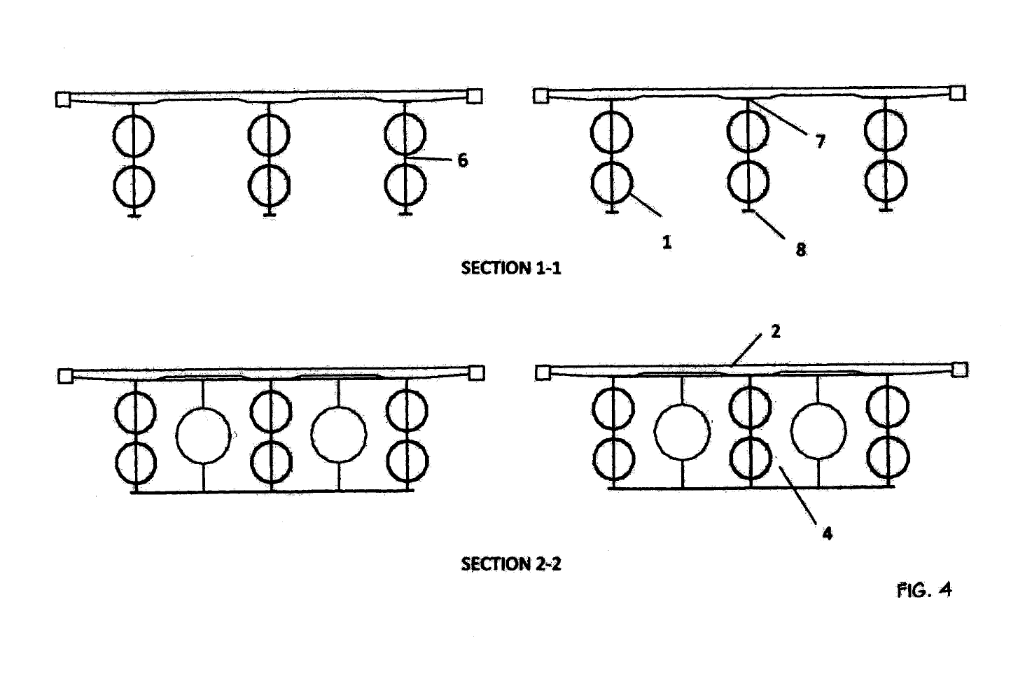

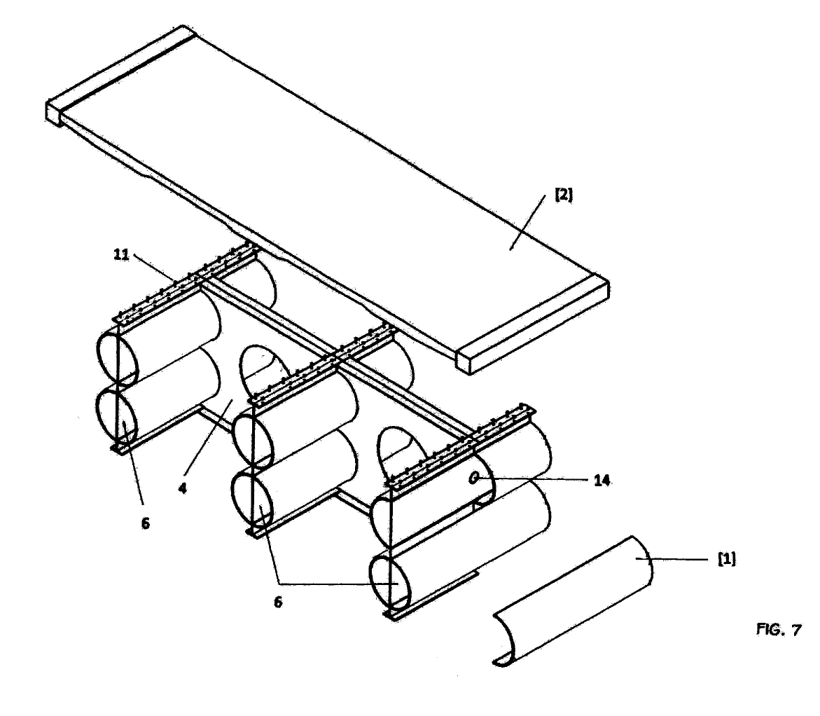

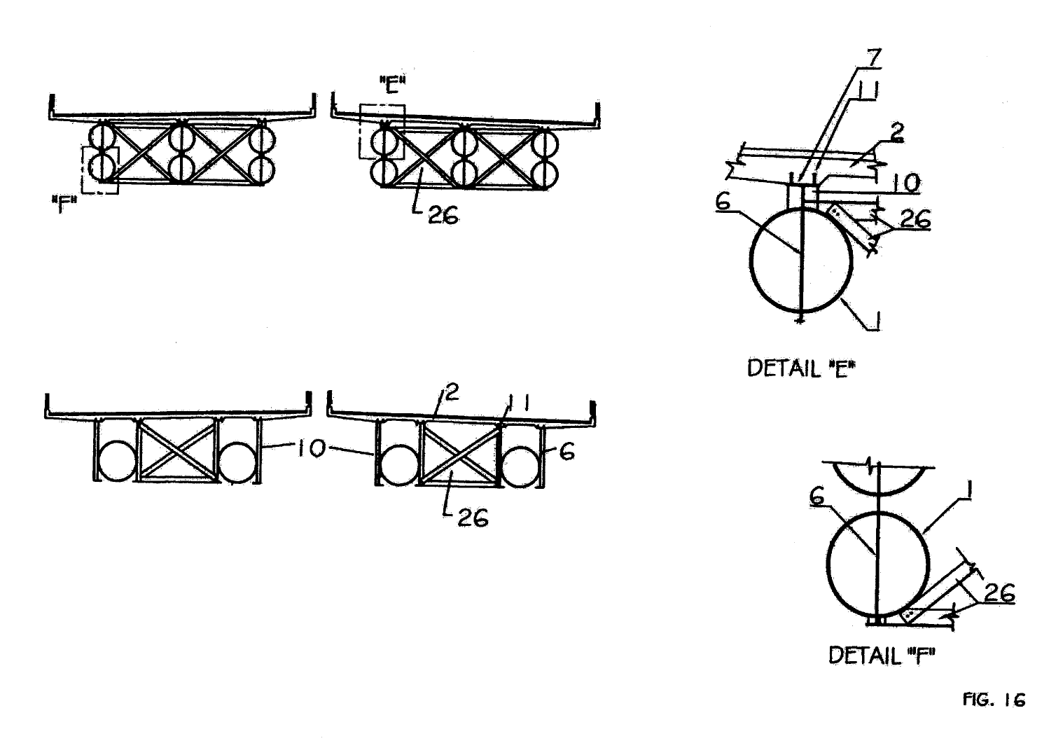

FIG. 4 is a partial cross-sectional view of a deck of the energy storage bridge depicted in FIG. 1A. Referring to FIG. 4, the part 1 is the steel pipes which are arranged in pairs in the depth direction. Alternatively, a single large diameter steel pipe may be used, as shown in the cross section in FIG. 16. The part 6 indicates a vertical web plate which connects the pipe 1 at the center line separating the pipe 1 into two halves. At the top of the web plate 6, a top flange plate 7 is welded to the end of the web plate 6. The top flange plate 7 is welded with shear connectors 11 as shown in FIG. 7, which is needed for the composite action between the steel part and the concrete slab 2. Referring to FIG. 4, a small bottom flange plate 8 is welded to the bottom end of the web plate 6. It is noted that in this embodiment, the concrete slab 2 may be substituted by a steel deck or by an orthotropic steel plate deck.

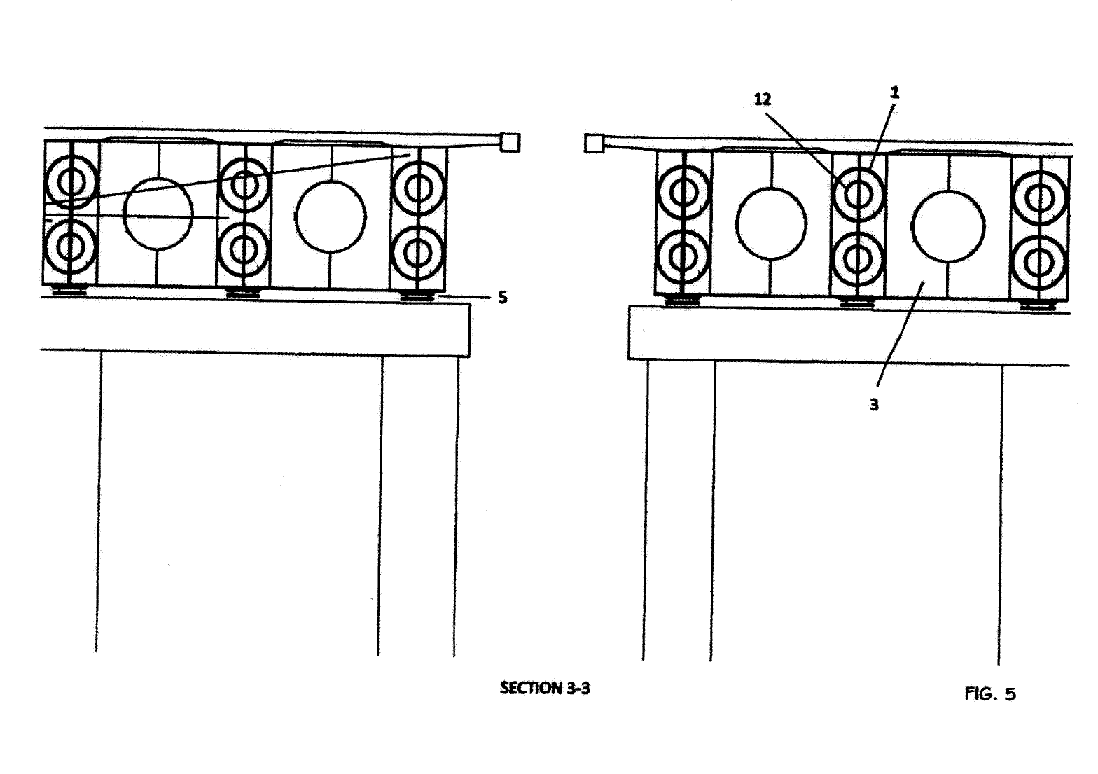

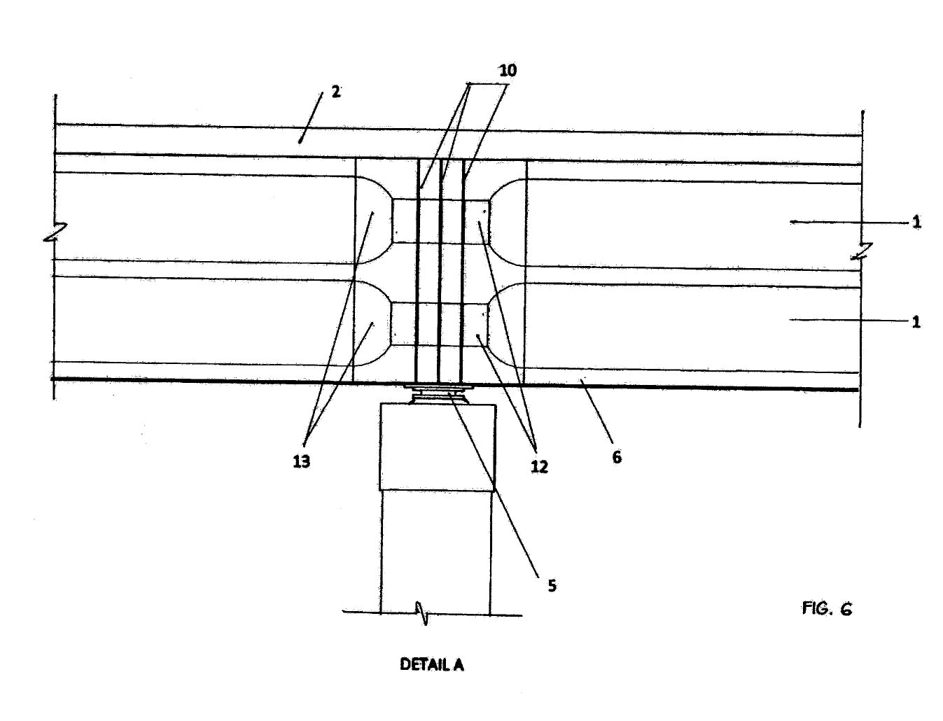

FIG. 5 is a partial cross-sectional view of the deck depicted in FIG. 4 showing a section of the deck close to the bridge bearing support. FIG. 6 is a side elevation view of the pipes at a pier support of the energy storage bridge depicted in FIG. 1A. Referring to FIG. 5 and FIG. 6, the web plate 6 is stiffened by the load bearing web stiffeners 10 which are required over the bearing 5 in order to transfer the concentrated load to the substructure. The diaphragm 3 could be replaced by a cross bracing system as shown in FIG. 16. Note the steel pipe 1 between two consecutive spans is linked by a smaller diameter short pipe 12. The short pipes are needed so that the web stiffeners 10 can have adequate structural width to transfer the loads to the support. This is because the web stiffener 10 should not be welded onto the short pipe 12 for allowing the short pipe to expand under internal air pressure. A clearance of 5 mm is recommended.

Referring to FIG. 6, the bridge dead load and live loads are transmitted to the pier via the webs 6 and the web stiffeners 10 down to the bridge bearing 5. As the load is a concentrated load at the bearing 5, the web plate 6 has to be stiffened by the web stiffeners 10 to prevent buckling. The web stiffeners 10 should be welded to the web plate 6 only, not to pipes 12. The large diameter pipe 1 is narrow down to about ½ of its diameter and a smaller diameter short pipe 12 is to connect the large diameter pipes 1 at the two adjacent spans. The load bearing stiffeners 10 are therefore having the structural width to be welded to the web plate 6. The part 11 is the shear connector.

FIG. 7 illustrates the assembly of a segment of the deck depicted in FIG. 4. In the cut out pipe, a hole 14 is shown in the web plate 6. This is needed at suitable locations (around midspan where the vertical shear force in the web 6 is less), to let the air inside the pipe move freely so as to balance the internal pressure of the steel pipes 1.

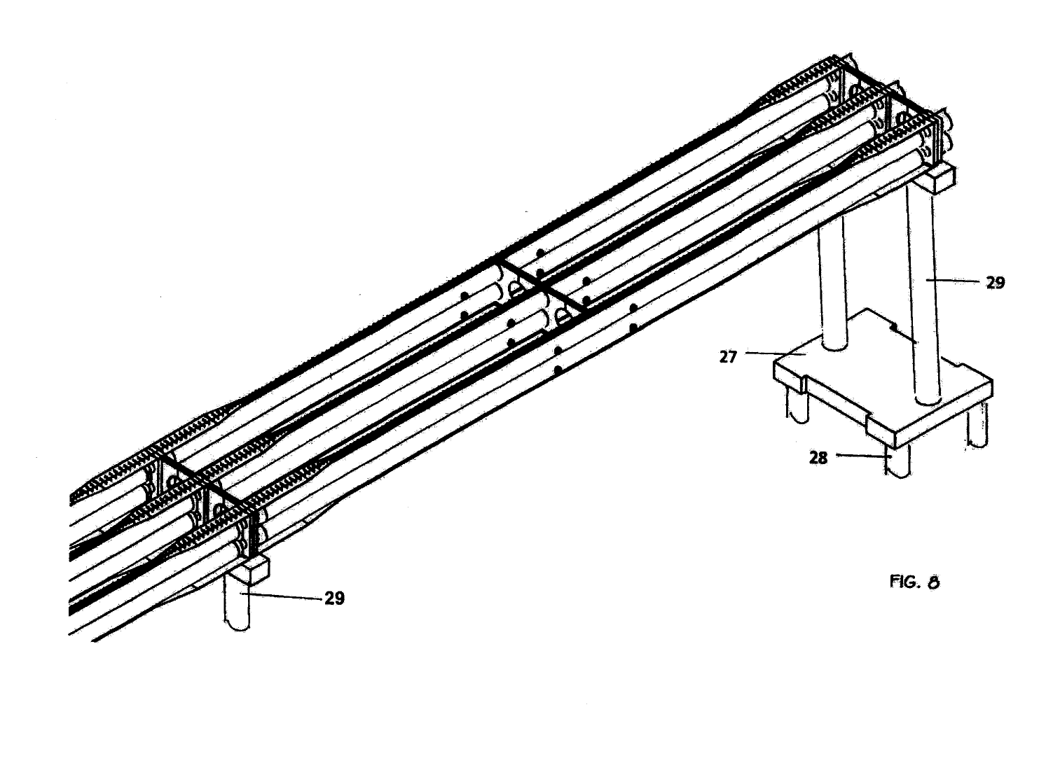

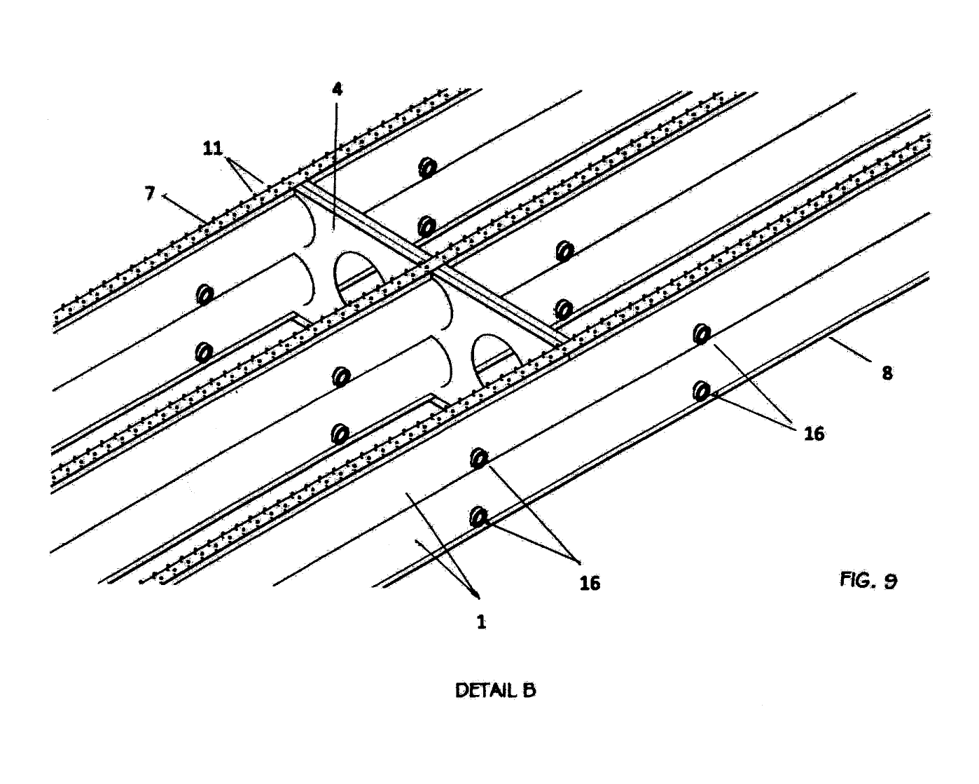

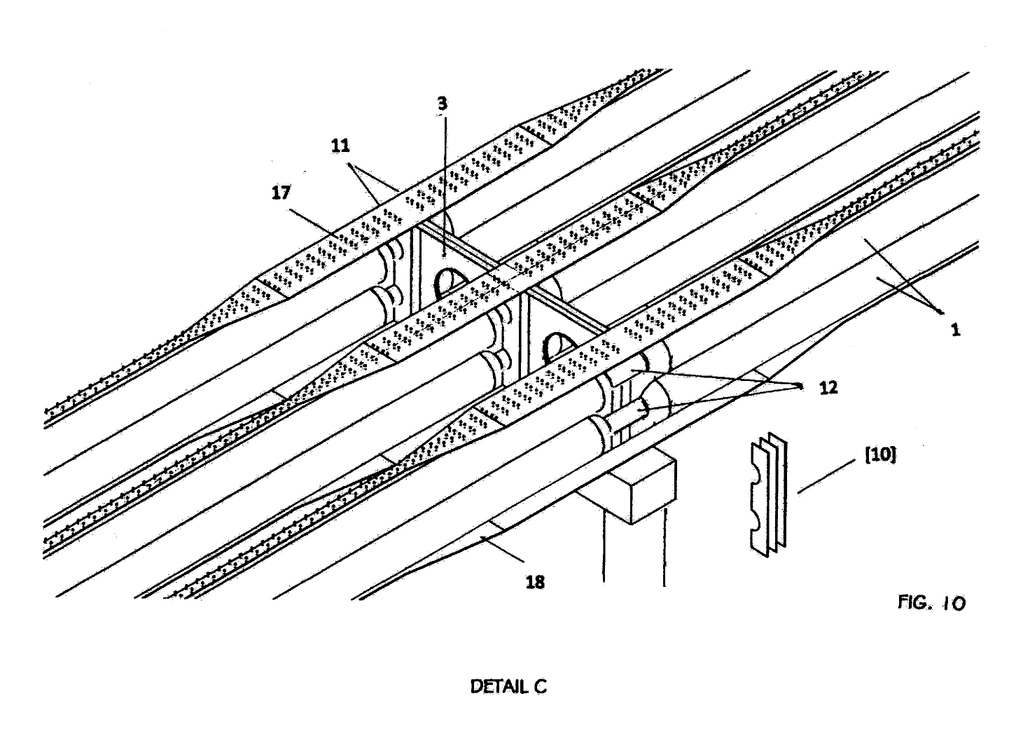

FIG. 8 illustrates the skeleton of a piping girder of the energy storage bridge depicted in FIG. 1A after the concrete slab is removed. FIG. 9 highlights the arrangement of the intermediate diaphragm 4 and the air pressure release units 16 around the diaphragm at the mid-depth of the pipe depicted in FIG. 6. FIG. 10 highlights the arrangement of the support diaphragm 3, the linkage pipe 12, the load bearing stiffeners 10 and the shear connectors 11 of the energy storage bridge depicted in FIG. 1A. Note that the enlarged top flange 17 over support may be needed to cater for the hogging moment of continuous structures.

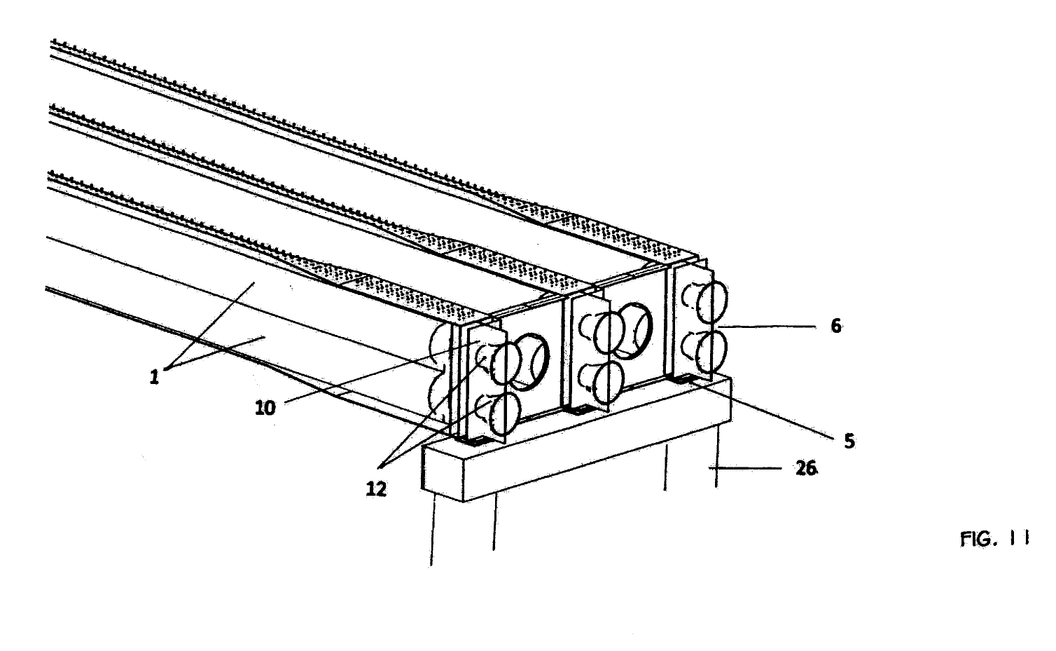

FIG. 11 is another partial perspective view of the energy storage bridge depicted in FIG. 10. The pressure in the pipes could rise above the designed highest working pressure, due to heat gained by the steel pipe wall from the surrounding atmosphere, or from any accidental heat due to, for example, a fire accident. The air compressor is unlikely to be able to pump air at pressure beyond its rating since the power input to the compressor cannot overcome the internal pressure. For safety, commercially available pressure release valves (not shown in FIG. 11) located at about ⅛ to ¼ of the span from the support are installed as the first line of safety measurement. The location is chosen on the basis that bending moment of a continuous beam is the least at this location. The valves are activated to release air when the internal pressure exceeds the preset pressure P1 and the valves return to their original positions after the air pressure drops back to the value below the preset pressure P1. Protection to the surrounding property and personnel is provided against the high speed air jets. The bridge is also designed to load the air jets as one of the loading cases.

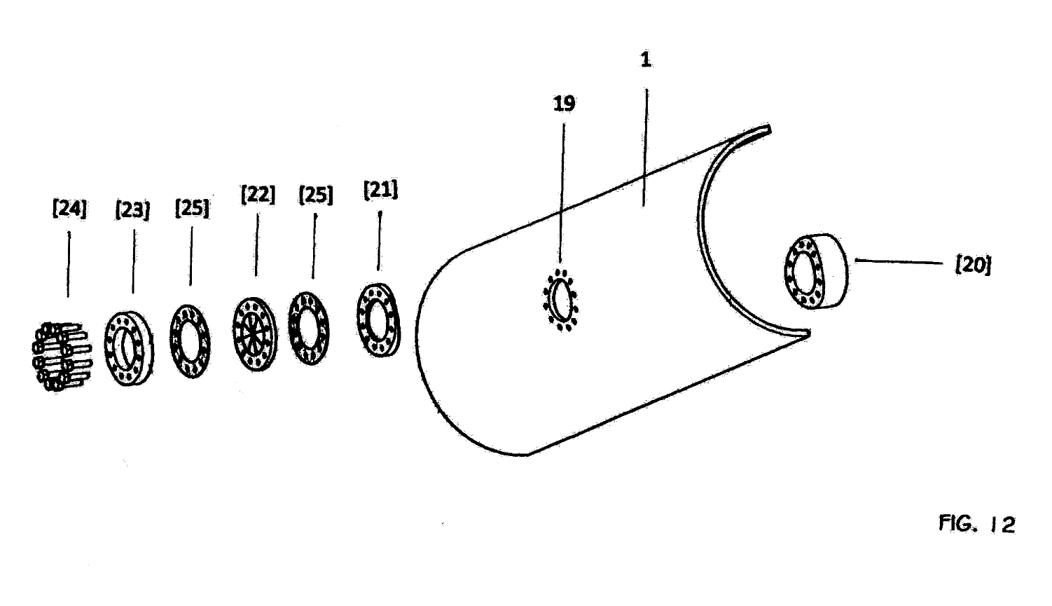

In case that the first line protection fails to activate the pressure valves at an air pressure higher than the preset pressure P1, a second line of protection will be activated when the air pressure is higher than the threshold pressure P2 (the pressure P2 is greater than the pressure P1). The steel pipes' designed ultimate pressure P3 is higher than the preset pressure P2 by a safety margin. FIG. 12 shows the pressure release unit “Sacrificial Valve”, as a second line safety measure in the energy storage bridge depicted in FIG. 10. It is based on the material strength of the gauge plate 22. The assembly includes a profiled bolt socket 20 which is welded to the wall of the steel pipe 1, a profiled washer 21, a gauge plate 22, a capping ring 23 and bolts 24. The gauge plate 22 is sandwiched with two flexible sealant rings 25. It is designed to be replaceable. Protection to the surrounding property and personnel is provided against the high speed air jet. The bridge is also designed to load the air jets as one of the loading cases.

The gauge plate 22 is pre-formed with grooves as shown in FIG. 12. The grooves help the plate yield and break along groove lines, under the threshold air pressure. By fine tuning the plate thickness, groove depth and width and the diameter of the hole, the gauge plate 22 can be designed to yield and break at air pressure below the designed ultimate air pressure that causes damage to the pipe wall 1 but above the preset air pressure P1 of the release valve (which is commercially available but not shown here). Once it is activated, the gauge plate (22) has to be replaced. The replacement starts with the removal of the capping ring 23 by unscrewing the long bolts 24.

The storage pipes 1 expand radially and axially under the internal pressure. If the expansion is restrained, lock-in stress will be set up. Therefore, the pipes 1 can only be restrained in one direction, as in the case of the web plate 6 being welded to the pipes 1 in the vertical direction. Expansion of the pipes 1 is then taken place in the transverse direction. By so doing, the expansion will not cause significant lock-in stress. A variation is to weld two webs, one on each side of the pipe as shown in FIG. 16. The pipe should be large diameter so that sufficient work spacing is provided internally.

The diaphragms 3, 4 can be substituted by cross frame as shown in FIG. 16. The diaphragms or any substituted cross-frame should not be connected to the side of the pipes 1. The diaphragm 3, 4 is detailed to have a gap between the pipe 1 and itself. The gap should be estimated by calculating the radial displacement of the pipe under the maximum air pressure.

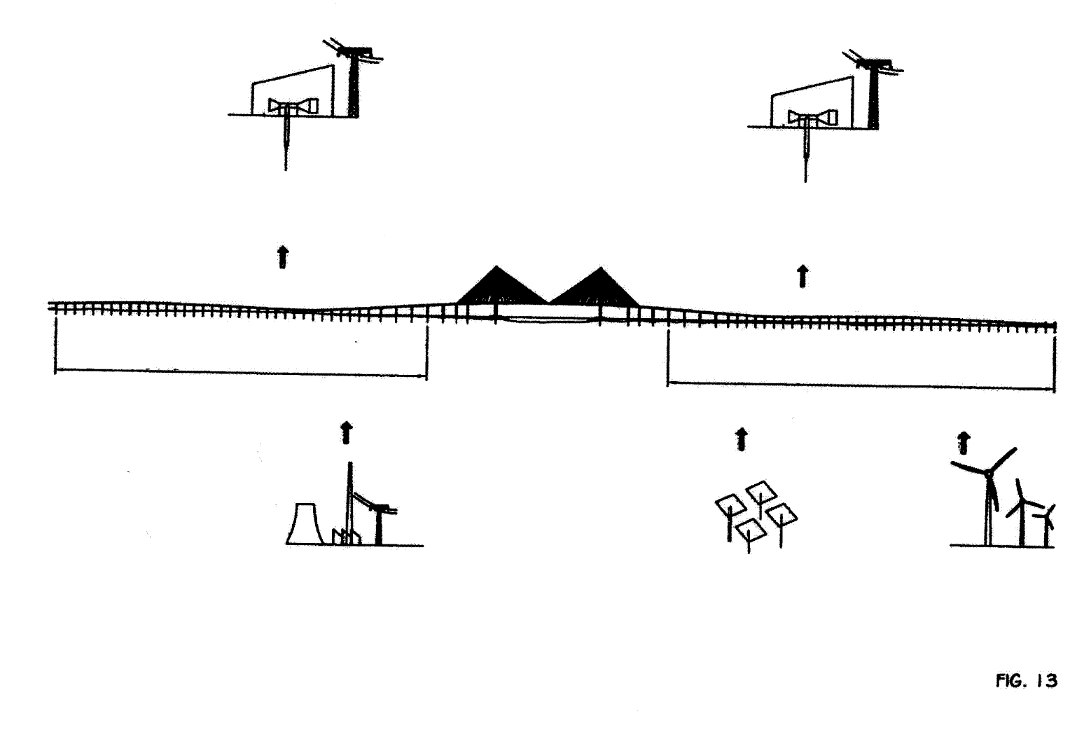

FIG. 13 shows the schematic application of the energy storage bridge as depicted in FIG. 1A to sea-crossing bridges. As these bridge crossings are all in great length such as the Sunshine Bridge of the USA, Oresund Bridge between Demark and Sweden, Hang Zhou Wan Bridge and Dong Hai Bridge of China, the storage they provide can be used as mass energy storage. Except for the main bridge in the navigation channel, the approach viaduct is well suitable for Energy Storage Bridge. For a dual carriageway bridge of 10 km in length, using a total of 6×2/1.5 m diameter pipes, the storage volume is 6×2×((pi)×1.5²/4)×10,000=212,057 m³. Comparing the figure with the storage volume in the Huntorf plant (two storages of 140,000 m³ and 170,000 m³ respectively) and the McIntosh plant (166,125 m³) the storage provided by the sea-crossing bridge is significant. For compressed air of 80 bars in the pipe, total energy can be estimated as P.V=8 MN/m²×212,000=1,696,000 MJ=471 MW-h. This puts it in the same class as the McIntosh plant.

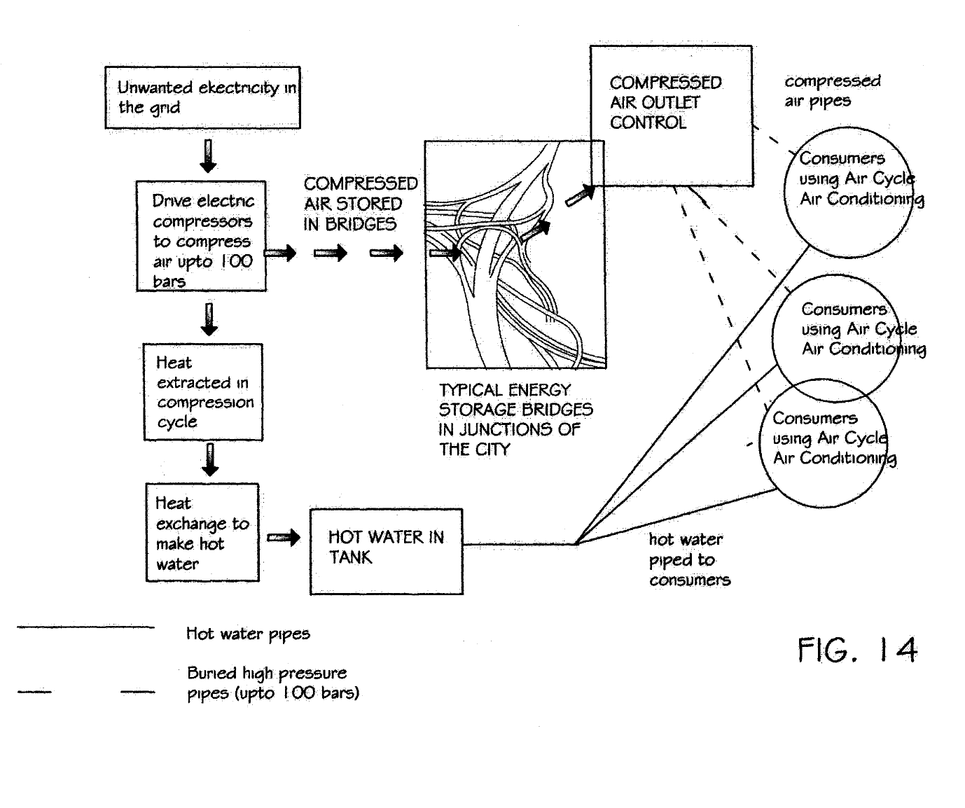

FIG. 14 shows the schematic application of the energy storage bridge as depicted in FIG. 1A to city road bridges, which are many in numbers but not in lengths. It is usually wide and the length averages from several hundred meters to kilometer long. For city bridges of over 1.0 km length with at least 3 lanes, the stored energy using the same structural form is 6×2×(pi)×1.5²/4×1000×2=170,000 MJ=11.75 MW-h. Considering only a much lower air pressure is needed since the energy demand in the nearby community is not in the power plant scale, 20 bars of pressure is used in this calculation. This is about 1/40 of the storage capacity of the McIntosh plant. This can be used as small energy storage for the local community. The stored compressed air can serve the community directly without the need to be converted back to electricity. FIG. 14 also shows an application of the stored compressed air in providing hot water and cool air to the local community for air conditioning.

The principle is that the heat is extracted when the air is compressed and the heat is used to heat water which is then stored in heat insulated tank. The compressed air is at temperature close to the ambient temperature (heat has been extracted to allow air to be compressed to ambient temperature). When the compressed air is decompressed and expands it will absorb heat-a so-called “Air Cycle Air Conditioning” (ACAC). The ACAC technology has been widely used in the commercial aircraft to provide air conditioning to the cabin. In the airplane, the compressed air comes from the aircraft turbo-fan engine. In this application, air is compressed by electric compressors during the low demand sessions of the day when the reserve of power in the grid is unwanted and is otherwise wasted if nobody takes it.

Unlike refrigerant based “Vapor Compression Cycle” air-conditioning, ACAC is refrigerant free hence it will not cause damage to the environment. In practice, the Bridge Storage Unit should be designed to store at least one-day power consumption in Energy for air-conditioning so that it can provide 24 hours service. This can be done with tandem storage units. The hot water and compressed air will supply to the local community by buried pipes.

This application has multiple benefits on environment. It saves the unwanted electricity in the grid. It turns the unwanted energy into wanted hot water and air-conditioning using refrigerant free ACAC technology. It improves the indoor air quality by ducting fresh cool air into the room, instead of circulating the indoor air as it does in the conventional air-conditioning.

All the technologies are available and matured. The innovation is the use of bridge body for energy storage using CASE technology and the application of compressed air to provide hot water and air-conditioning to the local community that the bridge belongs to.

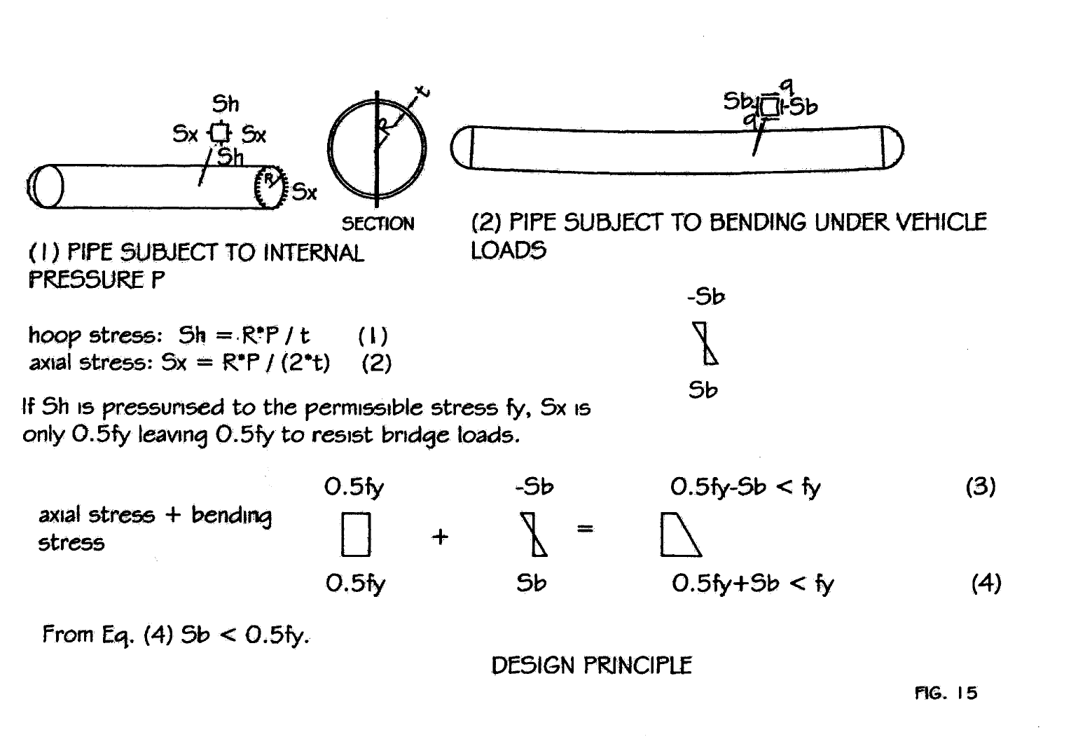

FIG. 15 illustrates the design principles of the energy storage bridge as depicted in FIG. 1A. It illustrates how the invention should be designed to achieve dual functions without the need to pay in full for each function. The stress in the steel pipe 1 subjected to an internal air pressure can be calculated by classical method according to Timoshenko and Woinowsky-Kriegers textbook “Theory of Plate and Shell”, McGraw-Hill Book Co., 2nd Ed., N.Y. 1959.

While the present patent application has been shown and described with particular references to a number of embodiments thereof, it should be noted that various other changes or modifications may be made without departing from the scope of the present invention.

What is claimed is:

1. An energy storage bridge comprising:
a plurality of bridge girders comprising:
a plurality of steel pipes configured to be used as load carrying structural members for carrying the bridge dead load and live loads comprising vehicle loads and configured to store energy in a form of compressed air contained therein, and
a plurality of web plates; and
a bridge deck disposed on top of the bridge girders and configured for loading the live loads;
wherein: the steel pipes are assembled in at least a row aligned vertically;
each web plate connects a row of the steel pipes at a center line separating the steel pipes into two halves;
each bridge girder forms an energy storage unit between two consecutive movement joints of the energy storage bridge;
every two consecutive storage units are joined by a high pressure flexible pipe to form a giant energy storage unit;
each energy storage unit is provided with inlet and outlet pipes to in-take compressed air from electric compressors driven by the grid power or by regenerated powers, and to release the compressed air to generate electricity; and
the bridge girders are disposed at a predetermined transverse spacing across the width of the bridge deck and configured for supporting the bridge deck as a roadway surface.

2. The energy storage bridge of claim 1, wherein the regenerated powers comprises wind and solar energies; the heat extracted from the air compression cycle is used to heat water which is stored in a heat-insulated tank; the water stored in the heat-insulated tank are supplied to consumers for hot water consumption; and the compressed air is supplied to the consumers for compressed air consumption for air conditioning.

3. The energy storage bridge of claim 1, wherein the bridge deck is a concrete slab or a steel deck or an orthotropic steel plate deck.

4. The energy storage bridge of claim 1 further comprising a plurality of web stiffeners welded to the web plates and configured for stiffening the web plates.

5. The energy storage bridge of claim 4, wherein the high pressure flexible pipes have a smaller diameter than the steel pipes and the web stiffeners are not welded to the high pressure flexible pipes.

6. The energy storage bridge of claim 1, wherein holes are formed in the web plates close to the midspan thereof, the holes being configured to let the air inside the steel pipes move freely so as to balance the internal pressure of the steel pipes.

7. The energy storage bridge of claim 1 further comprising a plurality of air pressure release units close to supports at the mid-depth of the steel pipes and a plurality of sacrificial valves, each sacrificial valve comprising a profiled bolt socket welded to the wall of the steel pipes, a profiled washer, a gauge plate, a capping ring and a plurality of bolts.

8. An energy storage bridge comprising:
a plurality of bridge girders comprising:
a plurality of steel pipes configured to be used as load carrying structural members for carrying the bridge dead load and live loads comprising vehicle loads and configured to store energy in a form of compressed air contained therein, and
a plurality of web plates; and
a bridge deck disposed on top of the bridge girders and configured for loading the live loads;
wherein: the steel pipes are assembled in at least a row aligned vertically;
two web plates are welded to two sides of each steel pipe respectively;
each bridge girder forms an energy storage unit between two consecutive movement joints of the energy storage bridge;
every two consecutive storage units are joined by a high pressure flexible pipe to form a giant energy storage unit;
each energy storage unit is provided with inlet and outlet pipes to in-take compressed air from electric compressors driven by the grid power or by regenerated powers, and to release the compressed air to generate electricity; and
the bridge girders are disposed at a predetermined transverse spacing across the width of the bridge deck and configured for supporting the bridge deck as a roadway surface.

9. The energy storage bridge of claim 8, wherein the regenerated powers comprises wind and solar energies; the heat extracted from the air compression cycle is used to heat water which is stored in a heat-insulated tank; the water stored in the heat-insulated tank are supplied to consumers for hot water consumption; and the compressed air is supplied to the consumers for compressed air consumption for air conditioning

10. The energy storage bridge of claim 8, wherein the bridge deck is a concrete slab or a steel deck or an orthotropic steel plate deck.

11. The energy storage bridge of claim 8 further comprising a plurality of web stiffeners welded to the web plates and configured for stiffening the web plates.

12. The energy storage bridge of claim 11, wherein the high pressure flexible pipes have a smaller diameter than the steel pipes and the web stiffeners are not welded to the high pressure flexible pipes.

13. The energy storage bridge of claim 8 further comprising a plurality of air pressure release units close to supports at the mid-depth of the steel pipes and a plurality of sacrificial valves.

14. The energy storage bridge of claim 13, wherein each sacrificial valve comprises a profiled bolt socket welded to the wall of the steel pipes, a profiled washer, a gauge plate, a capping ring and a plurality of bolts.

15. An energy storage bridge comprising:
a bridge girder comprising:
a steel pipe configured to be used as a load carrying structural member for carrying the bridge dead load and live loads comprising vehicle loads and configured to store energy in a form of compressed air contained therein, and
a plurality of web plates; and
a bridge deck disposed on top of the bridge girder;
wherein: each steel pipe is connected by two web plates on its two sides;
the bridge girder forms an energy storage unit between two consecutive movement joints of the energy storage bridge;
every two consecutive storage units are joined by a high pressure flexible pipe to form a giant energy storage unit;
each energy storage unit is provided with inlet and outlet pipes to in-take compressed air from electric compressors driven by the grid power or by regenerated powers, and to release the compressed air to generate electricity.

16. The energy storage bridge of claim 15 further comprising a plurality of web stiffeners welded to the web plates and configured for stiffening the web plates.

17. The energy storage bridge of claim 16, wherein the high pressure flexible pipes have a smaller diameter than the steel pipe and the web stiffeners are not welded to the high pressure flexible pipes.

18. The energy storage bridge of claim 15, wherein the bridge deck is a concrete slab or a steel deck or an orthotropic steel plate deck.

19. The energy storage bridge of claim 15 further comprising a plurality of air pressure release units around supports at the mid-depth of the steel pipe and a plurality of sacrificial valves, each sacrificial valve comprising a profiled bolt socket welded to the wall of the steel pipes, a profiled washer, a gauge plate, a capping ring and a plurality of bolts.

20. The energy storage bridge of claim 15, wherein the regenerated powers comprises wind and solar energies; the heat extracted from the air compression cycle is used to heat water which is stored in a heat-insulated tank; the water stored in the heat-insulated tank are supplied to consumers for hot water consumption; and the compressed air is supplied to the consumers for compressed air consumption for air conditioning.
